(19) United States
(12) Patent Application Publication
(10) Pub. No.: US 2004/0172644 A1
(43) Pub. Date: Sep. 2, 2004

(54) Optical head apparatus and optical disk apparatus using this optical head apparatus

(75) Inventor: Hiroshi Shinozuka, Fuchu-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/787,193

(22) Filed: Feb. 27, 2004

(30) Foreign Application Priority Data
Feb. 28, 2003 (JP) 2003-054681

(51) Int. Cl. G11B 7/08; G11B 7/085

(52) U.S. Cl. 720/683

(57) ABSTRACT

The present invention obtains drive forces symmetrical with a magnetic body at the center by holding the magnetic body positioned at the substantial gravity point of an actuator between two magnets in order to assure two magnetic circuits and arranging a focusing coil and tracking coils between the magnetic body and the both magnets.

### CROSS-REFERENCE TO RELATED APPLICATIONS

This application is based upon and claims the benefit of priority from prior Japanese Patent Application No. 2003-054681 filed Feb. 28, 2003,the entire contents of which are incorporated herein by reference.

### BACKGROUND OF THE INVENTION

1. Field of the Invention

The present invention relates to an optical head and an optical disk apparatus which are used to record information or reproduce information in an optical disk as an information recording medium.

2. Description of the Related Art

In recent years, demands for an increase in double speed that information can be recorded at a high double speed such as 8 to 48-fold speeds, a reduction in size or the like are growing with respect to an information recording/reproducing apparatus (optical disk apparatus). Based on this, rigorous design conditions are imposed on an optical disk apparatus which records information in an optical disk or reproduces information from the optical disk.

In particular, a high-speed access, i.e., a high sensitivity is demanded in regard to an actuator. A sensitivity of the actuator (AC sensitivity) is obtained as follows.

AC sensitivity=F/m, F=Biln

F is a motive energy and m is a mass of an actuator movable portion. As a method of increasing the sensitivity, there are improving a magnetic flux density, allowing a maximum current, increasing the winding number in an effective range and others.

It is needless to say that the sensitivity is improved by reducing a mass of the actuator. However, in an MC type actuator in which a coil is moved, a main mass of the actuator is a coil mass, and the winding number of the coil is in inverse proportion to an improvement in the sensitivity.

For example, Jpn. Pat. Appln. KOKAI Publication No. 2002-150599 discloses as a known actuator one in which a yoke is not arranged on a coil inner side but magnets face each other on both opposed end surfaces of a coil.

Further, in order to improve the sensitivity, there is a method based on an air-core coil or a drum winding in case of increasing the effective winding number of the coil. In this case, when a line shape of the coil is narrowed, there is a problem that a coil wire in especially a bent portion is narrowed due to a tensile force of winding, a loss is generated in the coil wire and a withstand current value becomes small. It is to be noted that a coating for insulation is required, and it is needless to say that this is a factor of increasing a cubic content.

Furthermore, arranging one (magnetic circuit) of the coils as heavy loads at a position away from a gravity point results in a problem that a reduction in sensitivity is provoked due to an increase in a gross weight.

On the other hand, when a plurality of yokes are arranged also on the inner side of the coil in accordance with directions of currents in order to improve the efficiency using the currents flowing through the coil as a motion power, not only an outer shape of the coil is increased but also a size of a movable portion is disadvantageously increased.

### BRIEF SUMMARY OF THE INVENTION

This invention is to provide an optical head apparatus comprising:

an object lens which condenses light beams onto a recording surface of an information recording medium or the like which records information therein;

a lens holder which holds the object lens so as to be movable in an optical axis direction of the object lens and a direction parallel to the recording surface of the information recording medium;

a magnet having surfaces on which an arbitrary magnetic pole is directed in one direction;

a coil which has coil surfaces, is provided in the lens holder, and generates a force in accordance with a magnetic field from the magnet in order to move the lens holder at least one of the optical axis direction and the direction parallel to the recording surface;

a magnetic body which reduces transmission of the magnetic field from the magnet which acts on the coil; and

a support member which supports the lens holder so as to be movable in a predetermined direction.

Furthermore, this invention is to provide an optical head apparatus comprising:

an optical head which has an object lens which condenses light beams onto a recording surface of an information recording medium or the like which records information therein; a lens holder which holds the object lens so as to be movable in an optical axis direction of the object lens and a direction parallel to the recording surface of the information recording medium; a magnet having surfaces on which an arbitrary magnetic pole is directed in one direction; a coil which has coil surfaces, is provided in the lens holder, and generates a force in accordance with a magnetic field from the magnet in order to move the lens holder at least one of the optical axis direction and the direction parallel to the recording surface; a magnetic body which reduces transmission of the magnetic field from the magnet which acts on the coil; and a support member which supports the lens holder so as to be movable in a predetermined direction;

a photodetector which detects light beams reflected on the recording surface of the recording medium and converts them into an electric signal; and

an information processing circuit which reproduces information recorded in the recording medium from the electric signal outputted from the photodetector.

### BRIEF DESCRIPTION OF THE SEVERAL VIEWS OF THE DRAWING

FIG. 1 is a perspective view illustrating an example of an optical disk apparatus including an optical head apparatus according to an embodiment of the present invention;

FIG. 2 is a schematic view illustrating an operation principle of the optical head apparatus;

FIG. 3 is a schematic view illustrating an example of a signal processing system in the optical disk apparatus described in connection with FIGS. 1 and 2;

FIG. 4 is a perspective view illustrating an example of an actuator to which the embodiment according to the present invention is applied;

FIG. 5 is a perspective view illustrating an example of the optical head apparatus to which an actuator is supported so as to be capable of being operated;

FIGS. 6A and 6B are perspective views illustrating examples of coils mounted in the optical head apparatus to which the embodiment according to the present invention is applied;

FIGS. 7A and 7B are plane views illustrating structures and operations of a focusing coil, tracking coils and magnets to which another embodiment according to the present invention is applied;

FIGS. 8A to 8D are plane views illustrating structures and operations of a focusing coil, tracking coils and magnets to which still another embodiment according to the present invention is applied;

FIG. 9 is a schematic view stereoscopically showing opposed coil surfaces and magnet surfaces shown in FIGS. 8A and 8B in a separated manner in order to facilitate understanding their relationship;

FIGS. 10A to 10D are perspective views illustrating examples of an actuator to which a flat coil shown in FIGS. 8A to 8D is incorporated;

FIG. 11 is a schematic view stereoscopically showing opposed coil surfaces and magnet surfaces in a separated manner in order to facilitate understanding their relationship when explaining a structure and an operation of the actuator depicted in FIG. 8A;

FIG. 12 is a schematic view stereoscopically showing opposed coil surfaces and magnet surface depicted in FIG. 8C in a separated manner in order to facilitate understanding their relationship;

FIG. 13 is a schematic view stereoscopically showing opposed coil surfaces and magnet surfaces in a separated manner in order to facilitate understanding their relationship when explaining a structure and an operation of the actuator depicted in FIG. 8C;

FIGS. 14A and 14B are schematic views showing examples of patterns of a flat coil depicted in FIG. 8A;

FIG. 15 is a schematic view showing examples of patterns of the flat coil depicted in FIG. 8A; and

FIGS. 16A and 16B are schematic views showing examples of patterns of the flat coil depicted in FIG. 8C.

### DETAILED DESCRIPTION OF THE INVENTION

Embodiments according to the present invention will now be described in detail hereinafter with reference to the accompanying drawings.

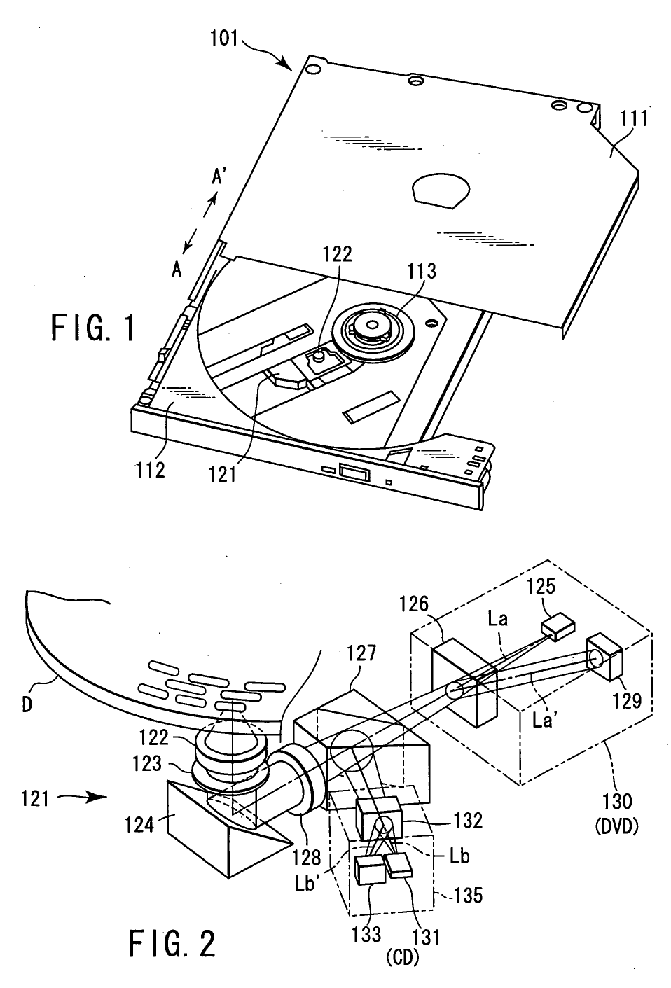

FIG. 1 shows an example of an optical disk apparatus including an optical head apparatus according to the present invention.

As shown in FIG. 1, an optical disk apparatus 101 has a housing 111 and a table unit 112 formed so as to be capable of performing an eject operation (movement in a direction indicated by an arrow A′) or a loading operation (movement in a direction indicated by an arrow A′) with respect to the housing 111.

A turn table 113 which rotates an optical disk D with a predetermined number of revolutions is provided at a substantially central part of the table unit 112. It is to be noted that a part of the optical head apparatus 121 and an object lens 122 incorporated in the optical head apparatus 121 are exposedly seen when the optical disk is not loaded in a state that the table unit 112 is being ejected.

FIG. 2 is a schematic view illustrating an operation principle of the optical head apparatus in a state that elements of the optical head apparatus 121 of the optical disk apparatus 101 are removed.

As shown in FIG. 2, the optical head apparatus 121 has an object lens 122 which condenses light beams, i.e., laser beams onto a recording surface of the optical disk D and fetches laser beams reflected on the optical disk D (which will be referred to as reflected laser beams hereinafter).

The object lens 122 can arbitrarily move in a (focusing) direction orthogonal to the recording surface of the optical disk D and a (tracking) direction orthogonal to guide grooves or recording mark columns provided on the recording surface by utilizing a later-described change in position of the actuator.

A dichroic filter 123 which gives predetermined optical characteristics of the laser beams directed to the optical disk D through the object lens 122 and the reflected laser beams from the optical disk D is provided at a predetermined position on a side opposite to the optical disk D of the object lens 122.

A prism mirror 124 which reflects the laser beams guided in substantially parallel to the recording surface of the optical disk D toward the object lens 122 is provided at a predetermined position on a front side of the dichroic filter 123, i.e., a side opposite to the object lens 122.

A first laser element 125 which emits, e.g., laser beams having a wavelength of a red color is provided at a position which is substantially parallel with the recording surface of the optical disk D and can causes the laser beams to enter the prism mirror 124. It is to be noted that the first laser element 125 is utilized for reproduction of information from, e.g., a DVD-standardized optical disk and writing of information to a CD-based and DVD-standardized optical disks.

A light receiving characteristic setting element 126 to which a diffraction grating and a no-polarizing hologram are integrally formed, a dichroic prism 127 and a collimator lens 128 are provided between the first laser element 125 and the prism mirror 124 in the order from a side close to the laser element 125. It is to be noted that a first photodetector 129 which detects the reflected laser beams from the optical disk D is placed at a position satisfying predetermined conditions with respect to a position where the first laser element 126 is provided. The reflected laser beams to which a predetermined grating is given by the light receiving characteristic setting element 126 enter this first photo-detector 129.

It is to be noted that the first laser element 125, the light receiving characteristic setting element 126 and the first photodetector 129 are integrated as a DVD-.oriented light emitting/light receiving unit (DVD-.IOU) 130.

A second laser element 131 which emits laser beams having, e.g., a near infrared wavelength is provided at a position where the laser beams can be caused to enter toward the prism mirror 124 after reflected by the dichroic prism 127. It is to be noted that the second laser element 131 is utilized for reproduction of information from, e.g., a CD-based optical disk.

An FM hologram element 132 which gives characteristics suitable for recording information in the optical disk D to the laser beams emitted from the second laser element 131 is placed at a predetermined position between the second laser element 131 and the dichroic prism 127. It is to be noted that a function which gives predetermined light receiving characteristics to the reflected laser beams from the optical disk D is also given to the FM hologram element 132.

A second photodetector 133 which detects the reflected laser beams from the optical disk D is provided at a position satisfying predetermined conditions with respect to a position where the second laser element 131 is provided. The reflected laser beams to which a predetermined grating is given by the FM hologram element 132 enter this second photodetector 133. It is to be noted that the second laser element 131, the FM hologram element 132 and the second photodetector 133 are integrated as a CD-oriented light emitting/light receiving unit (CD-IOU) 135.

In the optical head apparatus 121 shown in FIG. 2, when information is recorded from the DVD-based optical disk, predetermined wavefront characteristics are given to laser beams La having a wavelength of, e.g., 660 nm outputted from the first laser element 125 by the light receiving characteristic setting element 126, and the laser beams La are caused to enter the dichroic prism 127.

The laser beams La which has entered the dichroic prism 127 are transmitted through the dichroic prism 127 and collimated by the collimator lens 128, and an advancing direction thereof is bent toward the object lens 122 by the prism mirror 124.

The laser beams La directed toward the object lens 122 by the prism mirror 124 are condensed onto the recording surface of the optical disk D through the dichroic filter 123.

Since a light intensity of the laser beams La condensed on the recording surface of the optical disk D is modulated in a signal processing system which will be described later in accordance with information to be recorded, a recording mark, i.e., a pit is formed on a recording film of the optical disk D if an energy per time is an energy which can change a phase of the recording film.

The reflected laser beams La′ reflected on the recording surface of the optical disk D are returned to the prism mirror 124 through the dichroic filter 123, and their advancing direction is again bent in substantially parallel with the recording surface of the optical disk D.

The reflected laser beams La′ bent-by the prism mirror 124 are caused to enter the collimator lens 128 and led to the dichroic prism 127.

The reflected laser beams La′ returned to the dichroic mirror 127 are transmitted through the dichroic mirror 27 as they are, and directed toward the first photodetector 129 by the light receiving characteristic setting element 126.

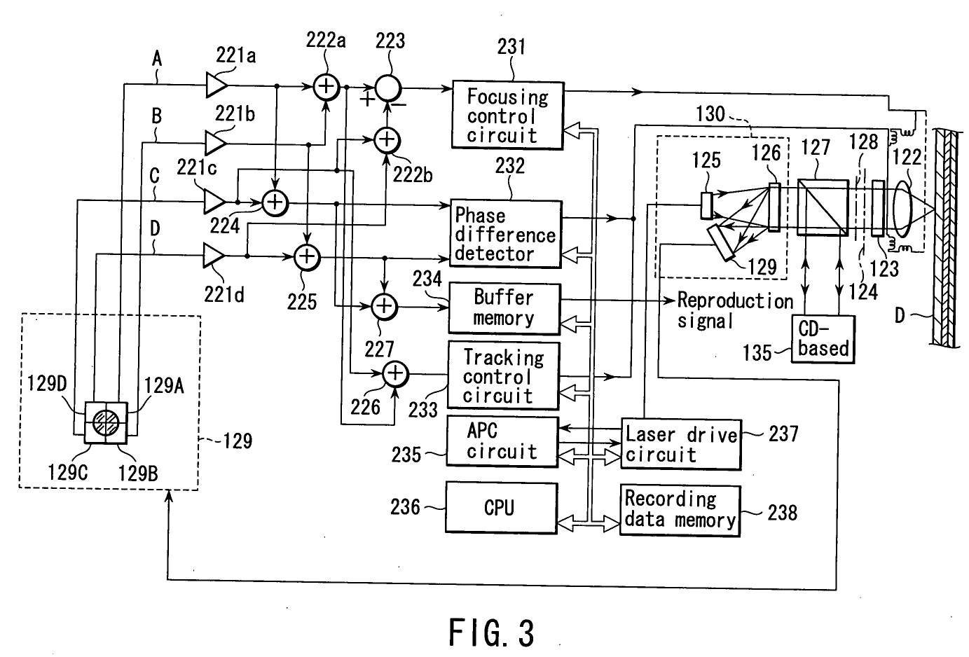

A part of the reflected laser beams La′ which have entered the first photodetector 129 is utilized for generation of a focusing error signal and a tracking error signal in a signal processing system shown in FIG. 3. That is, the object lens 122 is focus-locked at a position where a focus is achieved on the recording surface of the optical disk D, and tracking is controlled in such a manner that a center of tracks or pit columns of information pits previously formed on the recording surface matches with a center of the laser beams.

Furthermore, in cases where information is reproduced from the DVD-standardized optical disk, an intensity of the light beams La condensed on the recording surface of the optical disk D like the above- described storage of information is changed in accordance with the recording mark (pit column) recorded on the recording surface, and the light beams La are reflected from the optical disk D.

The reflected laser beams La′ reflected on the recording surface of the optical disk D are transmitted through the dichroic filter 123 and returned to the prism mirror 124, and their advancing direction is again bent in substantially parallel with the recording surface of the optical disk D.

The reflected laser beams La′ bent by the prism mirror 124 are caused to enter the collimator lens 128 and led to the dichroic prism 127.

The reflected laser beams La′ returned to the dichroic mirror 127 are transmitted through the dichroic mirror 127 as they are, and directed toward the first photodetector 129 by the light receiving characteristic setting element 126.

A part of the reflected laser beams La′ which have entered the first photodetector 129 is outputted to an external device or a temporary storage as a signal corresponding to a reproduction signal obtained by adding outputs from the first photodetector 129 in the signal processing system illustrated in FIG. 3.

On the other hand, in cases where information is reproduced in the CD-standardized optical disk, predetermined wavefront characteristics are given to laser beams Lb having a wavelength of, e.g., 780 nm outputted from the second laser element 131 by the FM hologram element 132, and the laser beams Lb are caused to enter the dichroic prism 127.

The laser beams Lb which have entered the dichroic prism 127 are reflected by the dichroic prism 127 and led to the collimator lens 128.

The laser beams Lb led to the collimator lens 128 are collimated by the collimator lens 128, and their advancing direction is bent toward the object lens 122 by the prism mirror 124.

The laser beams Lb directed toward the object lens 122 by the prism mirror 124 are transmitted through the dichroic filter 123 and condensed onto the recording surface of the optical disk D.

The reflected laser beams Lb′ reflected on the recording surface of the optical disk D are transmitted through the dichroic filter 123 and returned to the prism mirror 124, and their advancing direction is again bent in substantially parallel with the recording surface of the optical disk D. Then, the reflected laser beams Lb′ are returned to the dichroic prism 127 through the collimator lens 128.

The reflected laser beams Lb′ returned to the dichroic mirror 127 are reflected by the dichroic mirror 127, and directed toward the second photodetector 133 by the FM hologram element 132.

As a result, the reflected laser beams Lb′ whose intensity was changed in accordance with information recorded in the optical disk D and which was returned are caused to enter the second photodetector 133.

Thereafter, the reflected laser beams Lb′ are photoelectrically converted by the second photodetector 133, and their output is processed by the signal processing system which will be described later in connection with FIG. 3 and outputted to an external device or a temporary storage as a signal corresponding to information recorded in the optical disk D.

FIG. 3 is a schematic view illustrating an example of the signal processing system of the optical disk apparatus explained with reference to FIGS. 1 and 2. It is to be noted that reproduction of a signal from the CD-based optical disk (laser beams reflected on the dichroic prism) is omitted and reproduction of an output signal from the first photodetector, i.e., signal from the DVD-standardized optical disk, a focusing control and a tracking control will be mainly explained in FIG. 3.

The first photodetector 129 includes first to fourth domain photodiodes 129A, 129B, 129C and 129D. Outputs A, B, C and D from the respective photodiodes are amplified to a predetermined level by first to fourth amplifiers 221a, 221b, 221c and 221d, respectively.

In regard to the outputs A to D from the respective amplifiers 221a to 221d,A and B are added by a first adder 222a, and C and D are added by a second adder 222b.

As to outputs from the adders 222a and 222b, “(C+D) is added to (A+B) with signs being reversed” in an adder 223 (subtracted).

A result of addition (subtraction) by the adder 223 is supplied to a focusing control circuit 231 as a focusing error signal which is utilized to move the object lens 122 to a predetermined position in an optical axis direction running through the object lens in order to match a position of the object lens 122 with a focal distance which is a distance that the laser beams condensed through non-illustrated tracks previously formed on the recording surface of the optical disk D or non-illustrated pit columns as recording information and the object lens 122 are condensed.

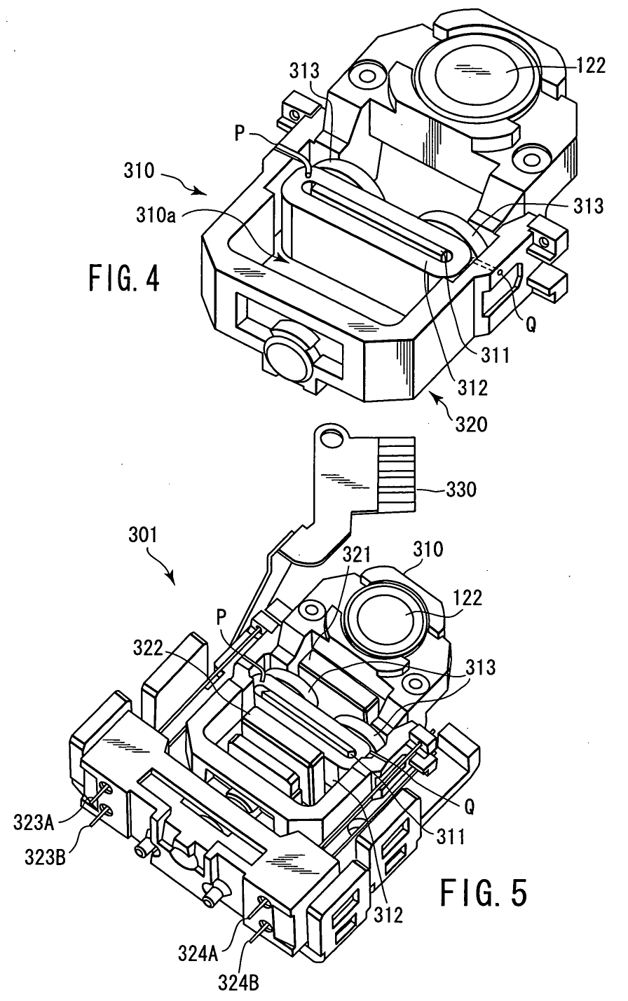

The object lens 122 is maintained on a predetermined track or pit column on the recording surface of the optical disk D in an on-focus state when a lens holder 310 (see FIG. 4) is moved in a predetermined direction by a thrust generated by a focusing control current supplied from a focusing control circuit 231 to a focusing coil 312 (see FIG. 4) based on a focusing error signal.

An adder 224 generates (A=C), and an adder 225 generates.(B=C). Outputs from the both adders, i.e., (A=C) and (B=D) are inputted to a phase difference detector 232. The phase difference detector 232 is useful for acquisition of a correct tracking error signal when the object lens 122 is lens-shifted.

A sum of (A=B) and (C=D) is obtained by an adder 226, and it is supplied to a tracking control circuit 233 as a tracking error signal which is utilized to move the object lens 122 in a direction parallel to the recording surface of the optical disk D in order to match a position of the object lens 122 with a center of non-illustrated tracks previously formed on the recording surface of the optical disk D or non-illustrated pit columns as recording information.

The object lens 122 is maintained on a predetermined track or pit column on the recording surface of the optical disk D in an on-track state when the lens holder 310 is moved in a predetermined direction by a thrust which is supplied from the tracking control circuit 233 to a tracking coil 313 (see FIG. 4) based on the tracking error signal and generated by the tracking control.

It is to be noted that since the object lens 122 is lens-shifted in accordance with an output from the phase difference detector 232, a center of the laser beams condensed by the object lens 122 is moved by a distance corresponding to a predetermined track before and after a current track.

(A=C) and (B=D) are further added by an adder 227, converted into an (A=B=C=D) signal, i.e., a reproduction signal and inputted to a buffer memory 234.

It is to be noted that an intensity of return light beams of the laser beams emitted from the first laser element 125 is inputted to an APC circuit 235. As a result, an intensity of recording laser beams emitted from the first laser element 125 based on recording data stored in a recording data memory 238 is stabilized.

In the optical disk apparatus 101 having such a signal detection system, when the optical disk D is set on the turn table 113 and a predetermined routine is activated-by a control of a CPU 236, the recording surface of the optical disk D is irradiated with reproduction laser beams from the first laser element 125 by a control of a laser drive circuit 237.

Thereafter, the reproduction laser beams are continuously emitted from the first laser element 125, and a signal production operation is started although the detailed explanation is eliminated.

FIG. 4 is a perspective view illustrating an example of an actuator to which the embodiment according to the present invention is applied.

As shown in FIG. 4, an opening portion 310a formed in such a manner that a later-described coil and magnetic material can be inserted is provided to an actuator 310.

The above-described object lens 122 is placed at a predetermined position on the actuator 310.

A focusing coil 312 provided so as to surround a periphery of a magnetic body 311 which can suppress transmission of magnetic fluxes with the magnetic body 311 at the center and tracking coils 313 which are attached on a side surface of the focusing coil 312 on the object lens 122 side or provided in the vicinity of the same are positioned at the substantially central part of the opening portion 310a. Moreover, the both coils and the actuator 310 are jointed to each other so as to be capable of supplying first and second currents based on the focusing error signal and the tracking error signal through connection terminals P and Q as described in conjunction with FIG. 3.

FIG. 5 is a perspective view illustrating an example of the optical head apparatus which supports the actuator 310 depicted in FIG. 4 so as to be movable in an arbitrary direction.

As shown in FIG. 5, the optical head apparatus 301 has an actuator base 320 having first and second magnets 321 and 322 which provide predetermined magnetic fields to the focusing coil 312 and the tracking coils 313 of the actuator 310 described with reference to FIG. 4.

The actuator 310 is supported so as to be movable in an arbitrary direction in a space defined by the opening portion 310a through four wire members (elastic members) 323a, 323B, 324A and 324B provided at predetermined positions of the actuator base 320.

In a state that the actuator 310 is supported by the actuator base 320, the first and second magnets 321 and 322 are arranged in parallel with a predetermined gap therebetween on both sides of the focusing and tracking coils 312 and 313. It is to be noted that the connection terminals P and Q are connected with the signal processing system shown in FIG. 3 through a wiring portion 330.

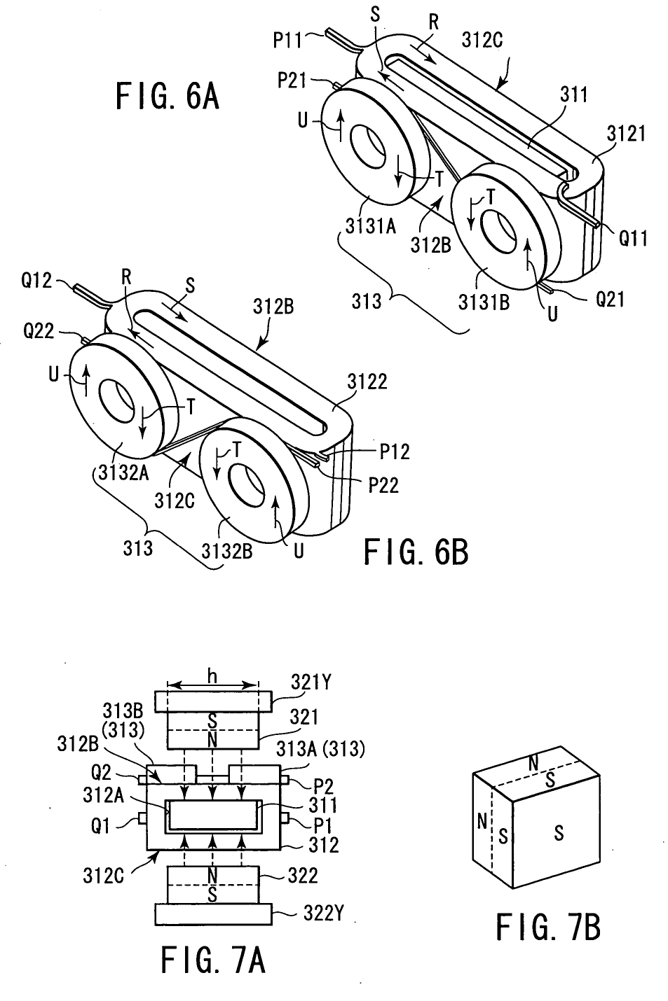

FIGS. 6A and 6B are perspective views showing examples of the coils mounted in the optical head apparatus to which the embodiment according to the present invention is applied. FIG. 6A shows an example that a coil obtained by winding a wire material around the magnetic body (drum winding coil) is utilized, and FIG. 6B shows an example that an air-core coil is utilized.

As shown in FIG. 6A, a focusing coil 3121 has two side surfaces (first and second coil surfaces 312B and 312C) in a longitudinal direction, and two tracking coils 3131A and 3131B are arranged on one side surface (e.g., 312B). Additionally, terminals P11 and Q11 are formed to the focusing coil 3121, and terminals P21 and Q21 are formed to the tracking coils 3131A and 3131, respectively.

In the focusing coil 3121, a conducting wire whose surface is insulated is wound around the magnetic body 311 as a core material with a predetermined number of turns in the clockwise direction from the terminal P11 side. For example, when a plus current is supplied to the terminal P11 and a minus current is supplied to the terminal Q11, a current in a direction indicated by an arrow S flows through the first coil surface 312B, and a current in a direction indicated by an arrow R flows through the second coil surface 312C, respectively. Therefore, the currents whose directions are opposite to each other flow through the first and second coil surfaces 312B and 312C, respectively.

The tracking coil 313 is constituted of two coils 3131A and 3131B arranged at positions symmetric with respect to the gravity point of the actuator 310 on one surface of the focusing coil 3121. The two coils 3131A and 3131B are formed by winding a conducting wire whose surface is insulated in the clockwise direction and then the counterclockwise direction with predetermined number of turns from the terminal P21 side as seen from the first magnet 321.

Therefore, for example, when a plus current is supplied to the terminal P21 and a minus current is supplied to the terminal Q21, respectively, the current flows through a part where the tracking coils 3131A and 3131B are adjacent to each other, i.e., a central part of the first coil surface 312B in a direction indicated by an arrow T, and the current flows through both ends of the tracking coil 3131 (ends of the first coils surface 312B) in a direction indicated by an arrow U.

Incidentally, it is needless to say that the currents flow in the reversed directions when the plus and minus voltages supplied to the terminals P11, Q11, P21 and Q21 are respectively reversed.

A description will now be given as to an example that an air-core coil using no core material shown in FIG. 6B is applied as a focusing coil. A focusing coil 3122 is obtained by winding a conducting wire whose surface is insulated in the clockwise direction with the predetermined number of turns from an terminal P12 side so as to be a rectangular with a predetermined size. Two tracking coils 3132A and 3132B are arranged on one side surface (e.g., 312C) of the focusing coil 3122. Terminals P12 and Q12 are formed to the focusing coil 3122 and terminals P22 and Q22 are formed to the tracking coils 3132A and 3132B, respectively. Therefore, currents flow like the iron-core coil described in conjunction with FIG. 6A.

Therefore, the tracking coils 3132A and 3132 may be arranged on either the first coil surface or the second coil surface.

FIGS. 7 are plane views illustrating structures and operations of the focusing coil and the tracking coils formed of the air-core coil or the iron-core coil and the magnets described in conjunction with FIGS. 4, 5, 6A and 6B. It is to be noted that the focusing coil, the tracking coils and the terminals shown in FIGS. 6A and 6B can be respectively adapted although they are different from reference numerals illustrated in FIGS. 4, 5 and 7A. Therefore, the focusing coil, the tracking coils and the terminals applied to the both types shown in FIGS. 6A and 6B will be described below by using reference numerals depicted in FIGS. 4, 5 and 7A.

First and second magnets 321 and 322 are magnets obtained by surface-magnetizing different poles on front and rear sides as shown in FIG. 7B. The first magnet 321 is fixed to a yoke 321Y formed by bending a predetermined part of the actuator base 320 into an L shape in such a manner that the magnetized surface becomes substantially parallel with one side surface of the magnetic body 311. Further, the second magnet 322 is fixed to a yoke 322Y in such a manner that the magnetized surface becomes substantially parallel with the other surface of the magnetic body 311. Moreover, the both magnets are arranged so that the opposed surfaces have the same magnetic pole, e.g., that the magnetic body side of the both magnets have an N pole.

The first magnet 321 is arranged in such a manner that the tracking coils 313A and 313B are opposed to effective areas of their adjacent coils (substantially central part of the first coil surface 312B). That is, a width h shown in FIG. 7A is formed into a width by which the both end portions of the tracking coils 313A and 313B through which a current whose direction is opposite to a current flowing through the substantially central part of the first coil surface 312B are not opposed to the magnet.

The magnet surface having the N pole opposed to the magnetic body 311 of the first magnet 321 forms magnetic fluxes which are transmitted through the substantially central part of the coil surface 312B, i.e., an effective area of the tracking coils 313 and directed toward the magnetic body 311. Further, the magnetic surface of the N pole opposed to the magnetic body 311 of the second magnet 322 forms magnetic fluxes which are transmitted through the coil surface 312C and directed toward the magnetic flux 311.

With this structure, it is possible to suppress a force which cancels out formed drive forces when the currents are supplied to the coils.

Furthermore, with this structure, magnetic circuits respectively formed on the first and second coil surfaces 312B and 312C are divided by the magnetic body 311 arranged at the center of the coils.

An operation principle of the actuator 310 will now be described. As explained with reference to FIGS. 6A and 6B, currents generated based on the focusing error signal are supplied to the terminals P1 and Q1 of the focusing coil 312. For example, a plus current is supplied to the terminal P1, and a minus current is supplied to the terminal Q1. As mentioned above, currents having predetermined directions (directions indicated by arrows S and R) flow through the focusing coil 312, and magnetic fluxes are formed in predetermined directions by the first and second magnets 321 and 322 and the magnetic body 311 as described in conjunction with FIG. 7A. Therefore, drive forces in the same upward focusing direction (direction vertical to the page space in FIG. 7A) are supplied to the both coil surface of the focusing coil 312.

Moreover, when the minus current is supplied to the terminal P1 and the plus current is supplied to the terminal Q1 based on the focusing error signal, drive forces in the same downward focusing direction are supplied to the both coil surfaces of the focusing coil 312.

Currents generated based on the tracking error signal are supplied to the terminals P2 and Q2 of the tracking coils 313. For example, a plus current is supplied to the terminal P2, and a minus current is supplied to the terminal Q2. As described above, currents in predetermined directions (directions indicated by arrows T and U) flow through the tracking coils, and magnetic fluxes are formed in predetermined directions by the first magnet 321 and the magnetic body 311 as explained in conjunction with FIG. 7A. Therefore, drive forces in the same rightward tracking direction (direction horizontal to the page space in FIG. 7A) are supplied to the adjacent coil surfaces of the tracking coils 313.

Additionally, when the minus current is supplied to the terminal P2 and the plus current is supplied to the terminal Q2 based on the tracking error signal, drive forces in the same leftward tracking direction. are supplied to the adjacent coil surfaces of the tracking coils 313.

It is to be noted that since the magnetic circuits respectively formed by using the first and second coil surfaces are divided by holding the magnetic body between the two coils as described above, the currents flowing through the coils can be utilized for motion forces (drive forces) with a high efficiency. Further, since the gravity point of the actuator is placed at the substantially central part of the magnetic body, the balance of the drive forces can be stabilized.

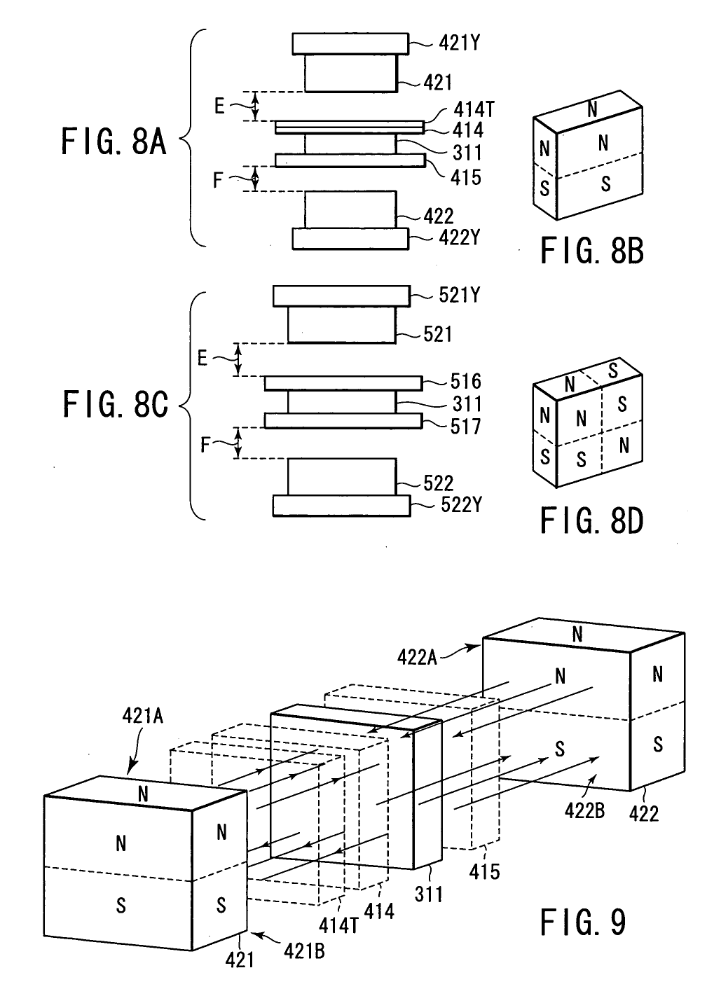

FIGS. 8A, 8B, 8C and 8D are schematic views illustrating examples that a flat coil is used in the actuator according to another embodiment of the present invention. It is to be noted that the examples shown in FIGS. 8A, 8B, 8C and 8D have the same structures except the focusing coil 312, the tracking coils 313 and the first and second magnets 321 and 322 of the optical head described in conjunction with FIG. 7A and hence the detailed explanation is eliminated.

First, as shown in FIG. 8B, a description will be given as to an example using surface-magnetized magnets so as to form different poles on upper and lower sides.

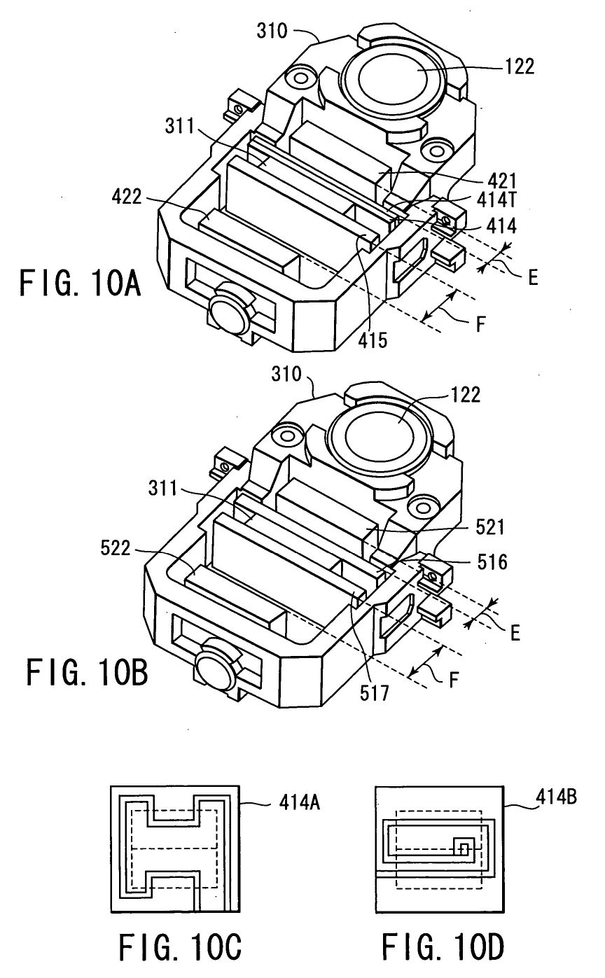

FIG. 9 is a schematic view stereoscopically showing opposed coil surfaces and magnet surfaces in a separated manner in order to facilitate a relationship between these surfaces. It is to be noted that FIGS. 10A and 10B are perspective views illustrating examples in which each of the flat coils depicted in FIGS. 8A and 8B and FIG. 9 is incorporated in the actuator.

As shown in FIG. 8A, the magnetic body 311 and the magnetized surfaces of the first and second magnets 421 and 422 are arranged in parallel, and the both magnets 421 and 422 are fixed to the actuator base through the yokes 421Y and 422Y, respectively. Of the magnetic body 311, an FPC (flexible print-circuit board) 414 is fixed on the first magnet 421 side, and an FPC 415 is fixed on the second magnet 422 side. Further, a tracking FPC 414T is arranged between the FCP 414 and the first magnet 421. The FPCs and the magnetic body are fixed to the actuator 310.

As shown in FIGS. 8A and 10A, a set of the FPC 414, the FPC 414T and the first magnet 421 and a set of the FPC 415 and the second magnet 422 are arranged with widths of a gap E and a gap F. At this time, the wire member is deformed when forces are concentrated on the side of the wire member supported by the actuator base 320, and it is preferable that the gap F is larger than the gap E in order to avoid a deterioration in performances.

However, in regard to drive forces generated by supply of the currents when the number of coil windings of the FPC 414 and the FPC 414T is equal to that of the FPC 415, the FPC 414 has the larger drive force due to the small gap E, and the front and rear sides may become off balance and a rotating force may be generated in some cases.

Therefore, the drive forces to be generated can be substantially uniformed on the front and rear sides of the magnetic body 311 (substantial gravity point of the lens holder movable portion) by reducing the number of coil windings of the FCP 414 and the FPC 414T on the small gap E side, i.e., reducing an overlap.

Moreover, in order to decrease an effective area (effective area of the coil which can act on an area where predetermined magnetic fields are formed) of the FCP 414 on the small gap E side, it is possible to use a coil 414A patterned into such a shape as shown in FIG. 10C. The coil 414A has a lead wire pattern formed in a predetermined part (central part) in an area where the magnetic fields are formed. Therefore, in the coil 414A, the effective area of the coil opposed to the magnets indicated by dotted lines is smaller than that of a coil 414B shown in FIG. 10D. Thus, drive forces to be generated can be also decreased.

As shown in FIG. 9, the first magnet 421 is arranged in such a manner that an upper magnet surface 421A of surfaces opposed to the magnetic body 311 has an N pole and a lower magnet surface 421B of the same has an S pole. The upper magnet surface 421A forms magnetic fluxes which are transmitted through the FPC 414T and 414 and directed toward the magnetic body 311, and the lower magnet surface 421B forms magnetic fluxes which are transmitted through the FPC 414T and 414 from the magnetic body 311 and directed toward itself.

Moreover, the second magnet 422 is arranged in such a manner that an upper magnet surface 422A of surfaces opposed to the magnetic body 311 has an N pole and a lower magnet surface 422B of the same has an S pole. The upper magnet surface 422A forms magnetic fluxes which are transmitted through the FPC 415 and directed toward the magnetic body 311, and the lower magnet surface 422B forms magnetic fluxes which are transmitted through the FPC 415 from the magnetic body 311 and directed toward itself.

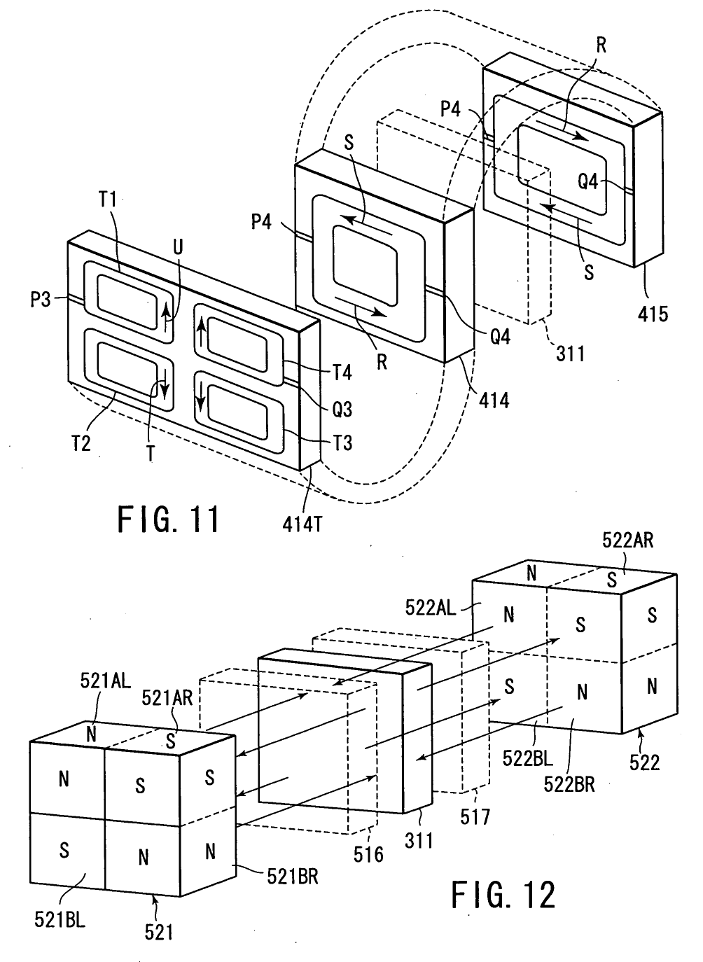

FIG. 11 is a schematic view illustrating still another example of the optical head apparatuses shown in FIGS. 8A, 8B, 9 and 10A. It is to be noted that FIG. 11 stereoscopically shows opposed coil surface and magnet surfaces in a separated manner in order facilitate a relationship between these surfaces when explaining a structure and an operation of the actuator.

As shown in FIG. 11, a focusing FPC 414F and a tracking FPC 414T are arranged so as to be parallel with each other on the first magnet 421 side (front side of the page space) of the magnetic body 311 in the order close to the magnetic body 311.

The tracking FPC 414T is formed by printing four coils T1 to T4 at predetermined positions on a single plane substrate and etching them.

The four coils T1 to T4 have convoluted shapes in the same direction from an outer periphery to an inner periphery, and a though hole is formed at the center of each coil. For example, as shown in FIG. 14A, the coils T1 to T4 are formed in the counterclockwise direction from the outer periphery toward the inner periphery as seen from the direction of the first magnet.

Terminals P3 and Q3 are provided at predetermined positions of an outer peripheral edge portion of the FPC 414T. The terminal P3 is connected with the coil T1, and the terminal Q3 is connected with the coil T4, respectively. The coil T1 is connected with the coil T2 via the through hole, and the coil T3 connected with the coil T2 by using a copper foil pattern is connected with the coil T4 via the through hole.

When a plus current is supplied to the terminal P3 and a minus current is supplied to the terminal Q3, currents in the same direction flow through the adjacent coil surface of the coils T1 and T4 and the coils T2 and T3 which are adjacent to each other in the tracking direction as shown in FIG. 14A. That is, of the central part of the FPC 414T, the current flows through the upper side where T1 and T4 are formed in a direction indicated by an arrow U (upward direction in the page space), and the current flows through the lower side where T2 and T3 are formed in a direction indicated by an arrow T (downward direction in the page space).

Moreover, as shown in FIG. 14B, the coils T1 to T4 may be formed in the clockwise direction from the outer periphery toward the inner periphery. When the plus current flows through the terminal P3 and the minus current flows through the terminal Q3, the current flows in a direction indicated by an arrow U on the upper side where T1 and T4 is formed and the current flows in a direction indicated by an arrow T on the lower side where T2 and T3 are formed in the central part of the FPC 414T.

Incidentally, when the directions of the currents supplied to the terminals P3 and Q3 are reversed, it is needless to say that the reversed currents flow on the upper and lower sides of the central part of the FPC 414T.

The FPC 415 is formed by printing coils having convoluted shapes in the counterclockwise direction from the outer periphery toward the inner periphery as seen from the direction of the first magnet 421 and etching them. It is to be noted that a plurality of coil sheets may be superposed on the FPC 415. Terminals P4 and Q4 are provided at predetermined positions of an outer peripheral edge portion of the FPC 415. When a plus current is supplied to the terminal P4 and a minus current is supplied to the terminal Q4, the current flows through the upper coil surface in a direction indicated by an arrow R (rightward direction in the page space) and the current flows through the lower coil surface in a direction indicated by an arrow S (rightward direction in the page space) as shown in FIG. 11.

The FPC 414 has coils convoluted in the counterclockwise direction from the outer periphery toward the inner periphery being printed thereto. Like the above-described FPC 415, this is an etched coil sheet. A plurality of coil sheets may be superposed in order to form the FPC 415. Terminals P4 and Q4 are provided at predetermined positions of the outer peripheral edge portion of the FPC 415. When the similar currents are supplied, the current flows through the upper coil surface in a direction indicated by an arrow S and the current flows through the lower coil surface in a direction indicated by an arrow R as shown in FIG. 11. It is to be noted that the terminals P4 and Q4 of the FPC 414 and the FPC 415 are respectively connected with each other, and the currents can be simultaneously supplied thereto.

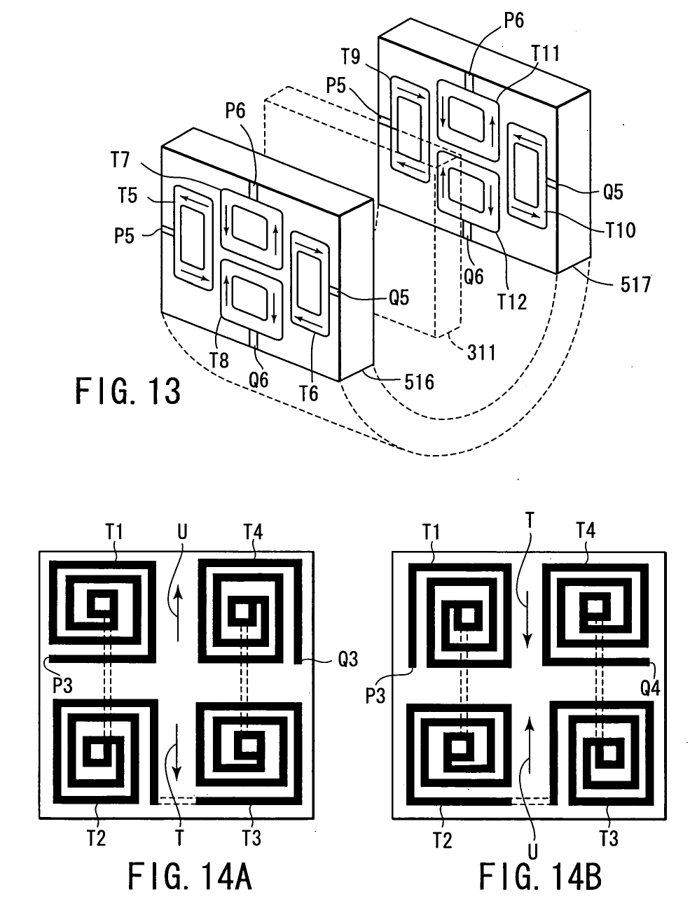

Further, the FPC can be constituted of one continuous substrate. In this case, as shown in FIG. 11 or FIG. 13, the FPC 415 and the FPC 414F are bent at a predetermined position so as to hold the magnetic body 311 therebetween. Furthermore, the FPC 414T can be bent at a predetermined position and superposed on the FPC 414F.

With this structure, the magnetic circuits formed on the respective first and second coil surfaces are divided by the magnetic body arranged at the center of the coil.

Moreover, the FPC 414T may be formed by superposing a plurality of coil sheets.

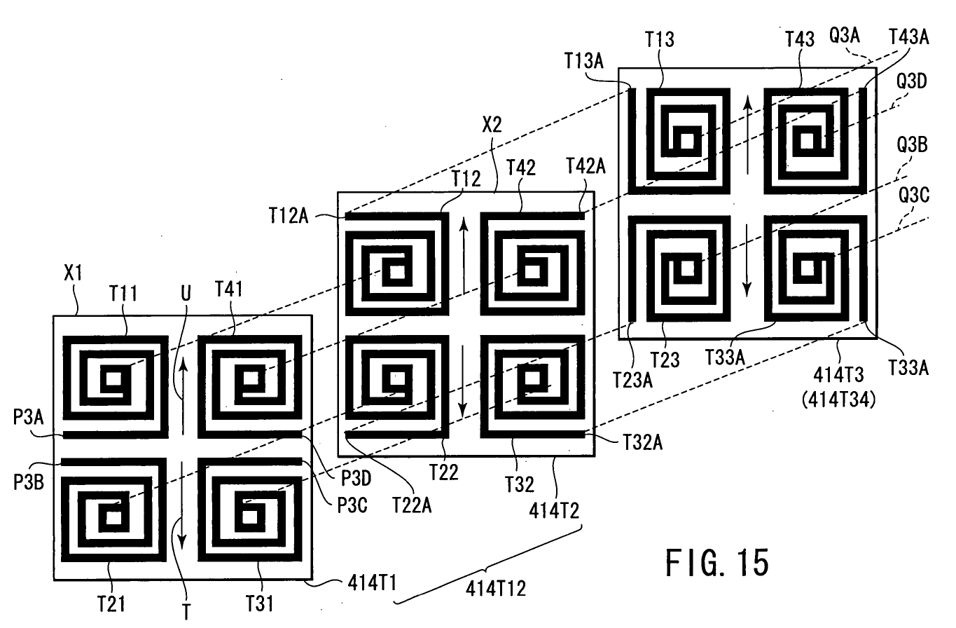

FIG. 15 is a schematic view showing an example of printing of coil sheets applied to the FPC 414T. FIG. 15 stereoscopically showing the respective coil sheets in a separated manner for facilitating the explanation.

As shown in FIG. 15, the first FPC 414T12 has four coils formed on one surface thereof, namely, eight coils are formed on both surfaces thereof. Coils T11, T21, T31 and T41 are formed on one surface 414T1, and coils T12, T22, T32 and T42 which are respectively connected via through holes are formed on the other surface 414T2. It is to be noted that the coils T12, T22, T32 and T42 have outer peripheral edge portions T12A, T22A, T32A and T42A.

The FPC 414T2 shown in FIG. 15 is integrally formed as a rear surface of the FPC 414T1. It is to be noted that an upper side X2 of the FPC 414T2 is matched with an upper side X1 of the FPC 414T1.

The FPC 414T34 has coils T13, T23, T33 and T43 formed on one surface 414T3 thereof. The coils T13, T23, T33 and T43 respectively have outer peripheral edge portions T13A, T23A, T33A and T43A.

The FPC 414T12 (FPC 414T1 and 414T2) and the FPC 414T34 (FPC 414T3) are connected with each other at the outer peripheral edge portions of their respective coils.

When plus currents are supplied to the terminals P3A and P3D and minus currents are supplied to the terminals Q3A and Q3D, the currents in the same direction flow through adjacent coil surfaces of the coils T11 and T41, the coils T12 and T42 and the coils T13 and T43 which are adjacent to each other in the tracking direction. That is, the currents flow through the central part on the upper side of the FPC in a direction indicated by an arrow U (upward direction in the page space).

Additionally, when plus currents are supplied to the terminals P3B and P3C and minus currents are supplied to the terminals Q3B and Q3C, the currents in the same direction flow through adjacent coil surfaces of the coils T21 and T31, the coils T2 and T32 and the coils T23 and T33 which are adjacent to each other in the tracking direction. That is, the currents flow through the central part on the lower side of the FPC in a direction indicated by an arrow T (downward direction in the page space).

In regard to the convoluted shapes of the coils, directions from the outer periphery toward the inner periphery of coils provided on a diagonal line on one surface (front surface), e.g., T11 and T31 or T21 and T41 are opposite to each other. Further, on the other surface (rear surface) of the both surfaces, the convoluted shapes are formed in the same directions. It is to be noted that the coils connected through the through holes respectively have convoluted directions opposite to each other.

For example, as shown in FIG. 15, the coils 21, T41, T12, T32, T23 and T43 are formed in the clockwise direction from the outer periphery toward the inner periphery as seen from the direction of the first magnet, and the coils T11, T31, T22, T42, T13 and T33 are formed in the counterclockwise direction from the outer periphery toward the inner periphery.

Therefore, all the coils may be formed so as have reversed directions. In such a case, when the above-described currents are supplied to the terminals, it is needless to say that the currents flow in the opposite directions.

Furthermore, although the description has been given as to the structure up to the front surface of the second coil in conjunction with FIG. 15, it is possible to superpose a plurality of coils sheets having coil patterns in which the above-described convolution directions are formed. Therefore, 414T12 is not necessarily formed to have coils on both surfaces thereof.

The operation principle of the actuator 310 will now be described.

As explained by using FIG. 11, currents generated based on the focusing error signal are supplied to the terminals P4 and Q4 of the FPCs 414 and 415. For example, a plus current is supplied to the terminal P4, and a minus current is supplied to the terminal Q4. As described above, currents flow through the FPCs 414 and 415 in predetermined directions. Furthermore, as described with reference to FIG. 9, magnetic fluxes are formed in predetermined directions (directions indicated by the arrows S and R) by using the first magnet 421 and the magnetic body 311. Therefore, upward drive forces in the tracking direction are generated in the FPCs 414 and 415.

Moreover, when a minus current is supplied to the terminal P4 and a plus current is supplied to the terminal Q4 based on the focusing error signal, the same downward drive forces in the focusing direction are supplied to the respective coil surface of the focusing coils 414 and 415.

Then, currents generated based on the tracking error signal are supplied to the terminals P3 and Q3 of the tracking coil 414T. For example, a plus current is supplied and a minus current is supplied to the terminal Q3. As described above, currents flows through the coils T1 to T4 in predetermined directions (directions indicated by arrows T and U). Additionally, as described in conjunction with FIG. 9, magnetic fluxes are formed in predetermined directions by using the first magnet 421 and the magnetic body 311. Therefore, rightward drive forces in the tracking direction (right-hand direction in the page space of FIG. 11) are generated from the upper coil surface of the FPC 414T, i.e., the coils T1 and T4. At the same time, rightward drive forces in the tracking direction are generated from the lower coil surface of the FPC 414T, i.e., the coils T2 and T3.

Therefore, the same rightward drive forces in the tracking direction are given to the tracking coil 414T at the central part thereof.

Further, when a minus current is supplied to the terminal P3 and a plus current is supplied to the terminal Q3 based on the tracking error signal, the same leftward drive forces in the tracking direction are given to the tracking coil 414T.

A description will now be given as to an example using a surface-magnetized magnet having different poles formed at upper, lower, right and left parts as shown in FIG. 8D.

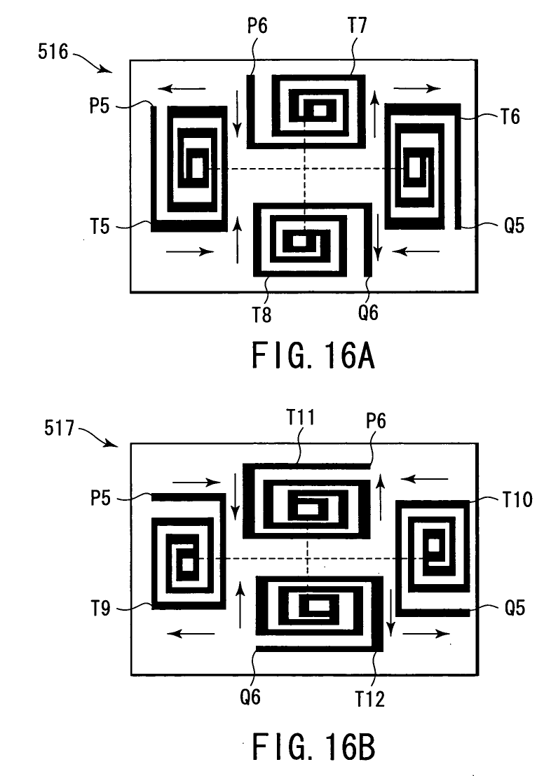

FIG. 12 is a schematic view stereoscopically showing opposed coil surfaces and magnet surface in a separated manner in order to facilitate a relationship between these surfaces. It is to be noted that FIGS. 10C and 10D are perspective views illustrating examples in which each flat coil depicted in FIGS. 8C, 8D and 12 is incorporated in the actuator. FIGS. 16A and 16B are perspective views showing examples of patterns of coils printed on the FPC depicted in FIG. 13.

As shown in FIG. 8C, the magnetic body 311 and the first and second magnets 521 and 522 are arranged in parallel, and the both magnets 521 and 522 are fixed to the actuator base through the yokes 521Y and 522Y. In regard to the magnetic body 311, an FPC 516 is fixed on the first magnet 521 side, and an FPC 517 is fixed on the second magnet 522 side.

As shown in FIG. 10B, a set of the FPC 516 and the first magnet 521 and a set of the FPC 517 and the second magnet 522 are arranged with a gap E and a gap F therebetween. As described above with reference to FIG. 10A, it is preferable that the gap F is larger than the gap E.

However, when the number of coil windings of the FPC 516 is equal to that of the FPC 517, the FPC 516 has a larger drive force generated upon supply of a current due to the small gap E, the front and rear sides may become off balance and a rotating force may be generated in some cases.

Therefore, the drive forces generated on front and rear sides of the magnetic body (substantial gravity point of the lens holder movable portion) can be substantially uniformed by reducing the number of coil windings of the FCP 516 on the smaller gap E side, i.e., decreasing an overlap.

As shown in FIG. 12, the FPC 516 is arranged on the first magnet 521 side of the magnetic body 311, and the FPC 517 is arranged on the second magnet 522 side of the same. The first magnet 521 is arranged in such a manner that a left magnet surface 521AL of an upper magnet surfaces in a surface opposed to the magnetic body 311 has an N pole and a right magnet surface 521AR of the same has an S pole in the page space. Therefore, it is arranged in such a manner a left magnet surface 521BL of lower magnet surfaces has an S pole and a right magnet surface 521BR of the same has an N pole. The magnet surfaces 521Al and 521BR form magnetic fluxes which are transmitted through the FPC 516 and directed toward the magnetic body 311, and the magnetic surfaces 521AR and 521BL form magnetic fluxes which are transmitted through the FPC 516 from the magnetic body 311 and directed toward themselves.

Further, the second magnet 522 is arranged in such a manner that a left magnet surface 522AL in the page space of an upper magnet surface in a surface opposed to the magnetic body 311 has an N pole and a right magnet surface 522AR of the same has an S pole. Therefore, it is arranged in such a manner that the left magnet surface 522BL of the lower magnet surface has the S pole and the right magnet surface 522BR of the same has the N pole. The magnet surfaces 522AL and 522BR form magnetic fluxes which are transmitted through the FPC 517 and directed toward the magnetic body 311, and the magnet surfaces 522AR and 522BL form magnetic fluxes which are transmitted through the FPC 517 from the magnetic body 311 and directed toward themselves.

FIG. 13 is a schematic view illustrating still another embodiment of the optical head apparatus illustrated in FIGS. 8C, 8D, 10B and 12. It is to be noted that FIG. 13 stereoscopically shows opposed coil surfaces and magnetic surfaces in a separated manner in order to facilitate a relationship between these surfaces.

As shown in FIG. 13, an FPC 516 is arranged on the first magnet 521 side of the magnetic body 311 and an FPC 517 is arranged on the second magnet 522 side (inner side of the page space) so as to be parallel with each other.

The FPC 516 has focusing coils T5 and T6 printed on the right and left sides (tracking direction) on a single plane substrate and tracking coils T7 and T8 printed on the upper and lower sides (focusing direction) on the same, and it is formed by etching. Further, the FPC 517 is also a plane substrate on which focusing coils T9 and T10 are formed on the right and left sides and tracking coils T11 and T12 are formed on the upper and lower sides. It is to be noted that the FPCs 516 and 517 may be formed by superposing a plurality of coil sheets. The focusing and tracking coils (T5 and T6, T7 and T8, T9 and T10, T11 and T12) are pairs connected via through holes at their centers on the single substrate, and they have convoluted shapes in the same direction from the outer periphery toward the inner periphery.

In regard to the convoluted shapes, as shown in FIGS. 16A and 16B, the coils T9 and T10 are formed in the clockwise direction from the outer periphery toward the inner periphery as seen from the direction of the first magnet, and the coils T5 to T8, T11 and T12 are formed in the counterclockwise direction from the outer periphery toward the inner periphery.

Terminals P5, Q5, P6 and Q6 are provided at predetermined positions at outer peripheral edge portions of the FPCs 516 and 517. The terminal P5 is connected with the coils T5 and T9, and the terminal Q5 is connected with the coils T6 and T10. Furthermore, the terminal P6 is connected with the coils T7 and T11, and the terminal Q6 is connected with the coils T8 and T12, respectively.

When a plus current is supplied to the terminal P5 and a minus current is supplied to the terminal Q5, currents in the leftward direction in the-page space flow through the upper coil surface of the coil T5 and the lower coil surface of the coil T6 opposed to the magnet surfaces 521AL and 521BR in the FPC 516 as shown in FIG. 15A. Moreover, currents in the rightward direction in the page space flow through the lower coil surface of the coil T5 and the upper coil surface of the coil T6 opposed to the magnet surfaces 521AR and 521BL. At the same time, as shown in FIG. 16B, currents in the rightward direction in the page space flow through the upper coil surface of the coil T9 and the lower coil surface of the coil T10 opposed to the magnet surfaces 522AL and 522BR in the FPC 517. Additionally, currents in the leftward direction in the page space flow through the lower coil surface of the coil T9 and the upper coil surface of the coil T10 opposed to the magnet surfaces 522AR and 522BL.

When a plus current is supplied to the terminal P6 and a minus current is supplied to the terminal Q6, currents in the downward direction in the page space flow through the left coil surface of the coil T7 and the right coil surface of the coil T8 opposed to the magnet surfaces 521AL and 521BR in the FPC 516. Further, currents in the upward direction in the page space flow through the right coil surface of the coil T7 and the left coil surface of the coil T8 opposed to the magnet surfaces 521AR and 521BL. At the same time, as shown in FIG. 16B, currents in the downward direction in the page space flow through the left coil surface of the coil T11 and the right coil surface of the coil T12 opposed to the magnet surfaces 522AL and 522BR in the FPC 517. Furthermore, currents in the upward direction in the page space flow through the right coil surface of the coil T11 and the left coil surface of the coil T12 opposed to the magnet surfaces 522AR and 522BL.

Moreover, the FPCs 516 and 517 can be constituted of one continuous substrate. In this case, the FPC 316 and the FPC 317 are bent so as to sandwich the magnetic body 311 therebetween in FIG. 13.

With this structure, magnetic circuits formed on each of the first and second coil surfaces are divided by the magnetic body arranged at the center of the coil.

The operational principle of the lens holder movable portion 310 will now be described.

As explained with reference to FIG. 13, currents generated based on the focusing error signal are supplied to the terminals P5 and Q5 of the FPCs 516 and 517. For example, a plus current is supplied to the terminal P5 and a minus current is supplied to the terminal Q5. The currents flow through the focusing coils T5, T6, T9 and T10 in the FPCs 516 and 517 in the predetermined direction as mentioned above, and the magnetic fluxes are formed in the predetermined direction by using the first and second magnets 521 and 522 and the magnetic body 311 as described in connection with FIG. 12. Therefore, the upward drive forces in the focusing direction (upward direction in the page space in FIG. 13) are generated in the focusing coils T5, T6, T9 and T10 of the FPCs 516 and 517.

Further, when currents generated based on the focusing error signal, e.g., a minus current and a plus current are supplied to the terminal P5 and the terminal Q5, respectively, downward drive forces in the focusing direction are generated on the predetermined coil surfaces of the focusing coils T5, T6, T9 and T10.

Subsequently, currents generated based on the tracking error signal are supplied to the terminals P6 and Q6. For example, a plus current is supplied to the terminal P6 and a minus current is supplied to the terminal Q6. As described above, the currents in the predetermined directions flow through the tracking coils T7, T8, T11 and T12. As mentioned above in conjunction with FIG. 12, the magnetic fluxes in the predetermined directions are formed by using the first and second magnets 521 and 522 and the magnetic body 311. Therefore, the leftward drive forces in the focusing direction are generated in the coils T7 and T8 of the FPC 516. At the same time, the rightward focusing drive forces are generated in the coils T11 and T12 of the FPC 517. Therefore, the actuator 310 can horizontally move the object lens 122 in a circular arc form around the magnetic body 311.

With this structure, the actuator 310 has the coil as a heavy load intensively mounted in the vicinity of the gravity point thereof, and can generate drive forces symmetrical with the gravity point at the center. Thus, a sensitivity of the actuator can be improved, and a weight of the entire apparatus can be reduced.

It is to be noted that the present invention is not restricted to the above-described embodiments, and various kinds of modifications/changes can be carried out without departing from its scope. Furthermore, the respective embodiments may be appropriately combined with each other and carried out and, in this case, advantages based on combinations can be obtained.

As described above, in the optical head apparatus according to the present invention, since the coils and the magnets are arranged so as to form magnetic circuits on the both surfaces of the magnetic body, currents flowing through the coils can be utilized with a high efficiency as drive forces required to change a position of the actuator. Moreover, since its gravity point is the substantially central part of the magnetic body, the balance of the drive forces can be stabilized.

Additionally, according to the present invention, it is possible to realize the optical head apparatus which is small in size, has a light weight and a high sensitivity.

Therefore, since the high-speed operation is enabled and the currents flowing through the coils are reduced, the optical disk apparatus with the small power consumption can be obtained.

What is claimed is:

1. An optical head apparatus comprising:
an object lens which condenses light beams onto a recording surface of an information recording medium or the like which records information therein;
a lens holder which holds the object lens so as to be movable in an optical axis direction of the object lens and a direction parallel to the recording surface of the information recording medium;
a magnet having surfaces on which an arbitrary magnetic pole is directed in one direction;
a coil which has coil surfaces, is provided in the lens holder, and generates a force in accordance with a magnetic field from the magnet in order to move the lens holder at least one of the optical axis direction and the direction parallel to the recording surface;
a magnetic body which reduces transmission of the magnetic field from the magnet which acts on the coil; and
a support member which supports the lens holder so as to be movable in a predetermined direction.

2. The optical head apparatus according to claim 1, wherein the coil surfaces of the coil are placed in substantially parallel with an arbitrary magnetized surface of the magnet in an non-operating state.

3. The optical head apparatus according to claim 2, wherein the coil is an air-core coil provided on an arbitrary side surface of the magnetic body.

4. The optical head apparatus according to claim 2, wherein the coil is a coil obtained by winding a wire material around the magnetic body with the predetermined number of turns.

5. The optical head apparatus according to claim 2, wherein the coil surfaces of the coil are formed into flat shapes on a sheet medium having a predetermined thickness.

6. The optical head apparatus according to claim 2, wherein the number of the coil surfaces of the coil is two, and the coil surfaces are provided with the magnetic body therebetween.

7. The optical head apparatus according to claim 6, wherein the coil is an air-core coil provided on an arbitrary side surface of the magnetic body.

8. The optical head apparatus according to claim 6, wherein the coil is a coil obtained by winding a wire material around the magnetic body with the predetermined number of turns.

9. The optical head apparatus according to claim 6, wherein the coil surfaces of the coil are formed into flat shapes on a sheet medium having a predetermined thickness.

10. An optical head apparatus comprising:
an optical head which has an object lens which condenses light beams onto a recording surface of an information recording medium or the like which records information therein; a lens holder which holds the object lens so as to be movable in an optical axis direction of the object lens and a direction parallel to the recording surface of the information recording medium; a magnet having surfaces on which an arbitrary magnetic pole is directed in one direction; a coil which has coil surfaces, is provided in the lens holder, and generates a force in accordance with a magnetic field from the magnet in order to move the lens holder at least one of the optical axis direction and the direction parallel to the recording surface; a magnetic body which reduces transmission of the magnetic field from the magnet which acts on the coil; and a support member which supports the lens holder so as to be movable in a predetermined direction;
a photodetector which detects light beams reflected on the recording surface of the recording medium and converts them into an electric signal; and
an information processing circuit which reproduces information recorded in the recording medium from the electric signal outputted from the photodetector.

11. The optical head apparatus according to claim 10, wherein the coil surfaces of the coil are positioned in substantially parallel with an arbitrary magnetized surface of the magnet in a non-operating state.

12. The optical head apparatus according to claim 11, wherein the coil is an air-core coil provided on an arbitrary side surface of the magnetic body.

13. The optical head apparatus according to claim 11, wherein the coil is a coil obtained by winding a wire material around the magnetic body with the predetermined number of turns.

14. The optical head apparatus according to claim 11, wherein the coil surfaces of the coil are formed into flat shapes on a sheet medium having a predetermined thickness.

15. The optical head apparatus according to claim 11, wherein the number of the coil surfaces of the coil is two, and the coil surfaces are provided with the magnetic body therebetween.

16. The optical head apparatus according to claim 15, wherein the coil is an air-core coil provided on an arbitrary side surface of the magnetic body.

17. The optical head apparatus according to claim 15, wherein the coil is a coil obtained by winding a wire material around the magnetic body with the predetermined number of turns.

18. The optical head apparatus according to claim 15, wherein the coil surfaces of the coil are formed into flat shapes on a sheet medium having a predetermined thickness.
